(19) United States
(12) Patent Application Publication
(10) Pub. No.: US 2016/0050913 A1
(43) Pub. Date: Feb. 25, 2016

(54) METHOD FOR MANUFACTURING AGRICULTURAL AND HORTICULTURAL GRANULE FORMULATION

(71) Applicant: NIPPON SODA CO., LTD., Tokyo (JP)

(72) Inventors: Kazuhiro Shimanuki, Takaoka-shi (JP); Nobuyuki TANAKA, Takaoka-shi (JP); Satoru YAMAMURA, Takaoka-shi (JP); Nasahiro URA, Takaoka-shi (JP)

(73) Assignee: Nippon Soda Co., Ltd., Chiyoda-ku, Tokyo (JP)

(21) Appl. No.: 14/779,040

(22) PCT Filed: Mar. 24, 2014
(86) PCT No.: PCT/JP2014/057970

§ 371 Date: Sep. 22, 2015

(30) Foreign Application Priority Data
Mar. 26, 2013 (JP) 2013-065229

(51) Int. Cl. A01N 25/12; A01N 43/08; A01N 43/88; A01N 43/40

(52) U.S. Cl. CPC A01N 25/12; A01N 43/40; A01N 43/08; A01N 43/88

(57) ABSTRACT

Provided is a method for producing an agricultural and horticultural granule,

the method including molding a powdered agrochemical composition into granules using a lateral extrusion granulator, characterized in that:

the lateral extrusion granulator includes

a hopper for feeding a kneaded product of the powdered agrochemical composition with water,

a screw for kneading and extruding the kneaded product,

a screw casing for accommodating the screw,

a screen for molding the kneaded product into strands, the screen being provided on a screw casing wall parallel to a screw shaft on a side away from the hopper, and

a cooling unit for cooling a screw casing wall on a bearing side of a screw on a side away from the hopper; and

the powdered agrochemical composition contains 20 to 80% by weight in total of a component having a water solubility of 4,000 to 500,000 ppm at a water temperature of 20° C. and a pH of 3 to 9.

### TECHNICAL FIELD

The present invention relates to a method for producing an agricultural and horticultural granule. More specifically, the present invention relates to a method for stably producing an agricultural and horticultural granule for a prolonged period of time in a continuous manner.

Priority is claimed on Japanese Patent Application No. 2013-065229, filed March 26, 2013, the content of which is incorporated herein by reference.

### BACKGROUND ART

Agricultural and horticultural granules have been produced by molding a powder containing an agrochemical active ingredient into granules by using a lateral extrusion granulator or a frontal extrusion granulator (Non-Patent Document 1).

In general, a lateral extrusion granulator is an apparatus having a hopper for feeding a powder, a screw casing, at least one screw that rotates inside the screw casing for kneading and extruding the fed powder, and a screen provided on a screw casing wall parallel to a screw shaft on the side away from the hopper for molding the kneaded powder into the form of strands, and is configured in such a manner that the temperature of the screw and the screw casing can be controlled by allowing a refrigerant to flow in the inner cavity of the screw shaft or in the inner cavity of the screw casing wall parallel to the screw shaft on the hopper side.

In those cases where continuous granulation is carried out, clogging of the screen of the granulator and local emissions of granulated products occur. These are caused by the frictional heat generated by the discharge characteristics and the continuous operation of the granulator, and the screen is dried and the clogging occurs by an increase in the temperature of the screen due to the frictional heat.

When the extrusion pressure at the time of granulation is high, even if the screen is clogged, a force generated by pressure from the inside acts so as to eliminate the clogging, thereby enabling a long term operation.

However, when the agrochemical active ingredient or the carrier is a water-soluble component, if the temperature of the kneaded product is high, the water-soluble component is dissolved in the added water, thereby increasing the ratio of water relative to solids and reducing the extrusion pressure at the time of granulation.

### CITATION LIST

### Non-Patent Document

Non-Patent Document 1 “MOSPILAN water-soluble granule” AGCHEM AGE, No. 193, 2012, 38-42 pages

### SUMMARY OF INVENTION

### Technical Problem

For this reason, in the conventional method for producing agricultural and horticultural granules, when attempts are made to mold an agrochemical composition containing a large amount of component with high water solubility into granules continuously for a long time using a lateral extrusion granulator, the screen is blocked at times. In addition, the strands extruded from the screen are fused with each other to form a lump like a yarn ball in some cases.

Accordingly, an object of the present invention is to provide a method for producing an agricultural and horticultural granule stably and also in a continuous manner for a long period of time by using an agrochemical composition containing a large amount of component with high water solubility.

### Solution to Problem

As a result of intensive studies in order to solve the above problems, the inventors of the present invention have completed the present invention which includes the following aspects.

[1] A method for producing an agricultural and horticultural granule which is a production method of an agricultural and horticultural granule by molding a powdered agrochemical composition into granules using a lateral extrusion granulator, the method characterized in that the aforementioned lateral extrusion granulator includes:

a hopper for feeding a kneaded product of the aforementioned powdered agrochemical composition and water;

a screw for kneading and extruding the aforementioned kneaded product;

a screw casing for accommodating the aforementioned screw;

a screen for molding the aforementioned kneaded product into strands which is provided on a screw casing wall parallel to a screw shaft on a side away from the aforementioned hopper; and

a cooling unit for cooling a screw casing wall on a bearing side of a screw on a side away from the aforementioned hopper,

wherein the aforementioned powdered agrochemical composition contains 20 to 80% by weight in total of a component having a water solubility of 4,000 to 500,000 ppm at a water temperature of 20° C. and a pH of 3 to 9.

The method for producing an agricultural and horticultural granule according to [1], wherein the aforementioned cooling unit is a spot cooler.

The method for producing an agricultural and horticultural granule according to [2], characterized in that a temperature of an air blown by the aforementioned spot cooler is from 0 to 25° C.

The method for producing an agricultural and horticultural granule according to any one of [1] to [3], characterized in that the aforementioned powdered agrochemical composition contains an agrochemical active ingredient having a water solubility of 4,000 to 500,000 ppm at a water temperature of 20° C. and a pH of 3 to 9.

The method for producing an agricultural and horticultural granule according to [4], characterized in that the aforementioned agrochemical active ingredient is a neonicotinoid-based insecticidal component.

The method for producing an agricultural and horticultural granule according to [5], characterized in that the aforementioned neonicotinoid-based insecticidal component is acetamiprid, dinotefuran, or thiamethoxam.

The method for producing an agricultural and horticultural granule according to any one of [1] to [6], characterized in that the aforementioned powdered agrochemical composition contains a carrier having a water solubility of 4,000 to 500,000 ppm at a water temperature of 20° C. and a pH of 3 to 9.

The method for producing an agricultural and horticultural granule according to [6], characterized in that the aforementioned carrier is a metal halide salt, a metal carbonate salt, a metal sulfate salt, an ammonium salt, urea, a monosaccharide, a disaccharide, or a polysaccharide.

### Advantageous Effects of Invention

According to the method of the present invention, in the production of an agricultural and horticultural granule, it is possible to produce an agricultural and horticultural granule continuously for a long time without causing the strands extruded from the screen to be fused with each other and without causing the screen blockage even when the agrochemical composition contains a large amount of component having a high water solubility.

### BRIEF DESCRIPTION OF DRAWINGS

FIG. 1 is a side perspective view of a lateral extrusion granulator to be used in a production method according to an embodiment of the present invention.

FIG. 2 is a top perspective view of a lateral extrusion granulator to be used in a production method according to an embodiment of the present invention.

FIG. 3 is a diagram showing an embodiment of a granule production facility.

### DESCRIPTION OF EMBODIMENTS

An embodiment of the present invention will be described with reference to the drawings. However, the present invention is not limited to the embodiment described herein, and also includes those that are obtained by modifying, adding or omitting the configuration within a range that does not contradict the gist of the present invention.

A method for producing an agricultural and horticultural granule according to the present invention includes a step of molding a kneaded product 2 of a powdered agrochemical composition and water into granules by using a lateral extrusion granulator 1.

The aforementioned powdered agrochemical composition contains a total of 10 to 90% by weight, preferably 20 to 80% by weight, and more preferably 25 to 65% by weight, of a component having a water solubility of 4,000 to 500,000 ppm (at a water temperature of 20° C., and a pH of 3 to 9).

The aforementioned powdered agrochemical composition can contain, as the aforementioned component having a water solubility of 4,000 to 500,000 ppm (at a water temperature of 20° C., and a pH of 3 to 9), an agrochemical active ingredient having a water solubility of 4,000 to 500,000 ppm (at a water temperature of 20° C., and a pH of 3 to 9). Examples of such agrochemical active ingredients include sodium 1-naphthaleneacetate, MDBA potassium salt, acetamiprid, iminoctadine acetate, iminoctadine albesilate, imicyafos, glyphosate ammonium salt, glyphosate isopropylamine salt, glufosinate, glufosinate-P sodium salt, dinotefuran, cyromazine, daminozide, thiamethoxam, tefuryltrione, topramezone, pyrimisulfan, flucetosulfuron, flonicamid, foramsulfuron, mesotrione, metalaxyl, metalaxyl-M, methyl iodide, and metazosulfuron. These active ingredients may be used alone or may be used by mixing several kinds thereof.

In addition, among these active ingredients, a neonicotinoid-based insecticidal component is preferred, and acetamiprid, dinotefuran, and thiamethoxam are more preferred.

The aforementioned powdered agrochemical composition can contain, as the aforementioned component having a water solubility of 4,000 to 500,000 ppm (at a water temperature of 20° C., and a pH of 3 to 9), a carrier having a water solubility of 4,000 to 500,000 ppm (at a water temperature of 20° C., and a pH of 3 to 9). As such a carrier, inorganic salts and saccharides are preferred.

As the inorganic salts, for example, a metal halide salt (example: potassium chloride, sodium chloride, calcium chloride, and the like), a metal carbonate salt (example: sodium carbonate, aluminum carbonate, and the like), a metal sulfate salt (example: sodium sulfate, magnesium sulfate, copper sulfate, and the like), an ammonium salt (example: ammonium chloride, ammonium sulfate, ammonium nitrate, and the like), urea and the like can be mentioned.

As the saccharides, monosaccharides (example: glucose, galactose, and the like), disaccharides (example: sucrose, lactose, white sugar, and the like), polysaccharides (example: starch, and the like), and the like can be exemplified, although disaccharides are preferred, and lactose is particularly preferred.

These inorganic salts or saccharides may be used alone or several kinds thereof may be mixed.

The aforementioned powdered agrochemical composition may further contain other technical products. As such a technical product, for example, azimsulfuron, acequinocyl, azoxystrobin, abamectin, amisulbrom, alachlor, isotianil, isoprothiolane, ipfencarbazone, imicyafos, imidacloprid, imibenconazole, indaziflam, indanofan, indoxacarb, indoxacarb-MP, uniconazole-P, esprocarb, ethaboxam, ethychlozate, ethiprole, etoxazole, etofenprox, oxadiazon, oxadiargyl, oxaziclomefone, oxolinic acid, orysastrobin, cadusafos, cafenstrole, carpropamid, cumyluron, kresoxim-methyl, clothianidin, chromafenozide, clomeprop, chlorantraniliprole, chlorfenapyr, chlorphthalim, cyazofamid, cyenopyrafen, diclocymet, dithianon, dithiopyr, difenoconazole, cyflufenamid, cyflumetofen, simeconazole, dimethametryn, dimethenamid-P, dimethomorph, silafluofen, spinetoram, spinosad, spirodiclofen, spirotetramat, spiromesifen, daimuron, tiadinil, thifluzamide, tebuconazole, tebufenozide, tebufloquin, trinexapac-ethyl, trifloxystrobin, tolfenpyrad, trifluralin, novaluron, paclobutrazol, halosulfuron-methyl, bifenazate, bifenthrin, pymetrozine, pyraclostrobin, pyraclonil, pyraflufen-ethyl, pyriofenone, pyridaben, pyridalyl, pyriftalid, pyributicarb, pyrifluquinazon, pyriproxyfen, pyribencarb, pyrimisulfan, pyriminobac-methyl, fenoxanil, ferimzone, fenamidone, fentrazamide, fenpyrazamine, fenbuconazole, fenhexamid, butachlor, butamifos, buprofezin, furametpyr, fluacrypyrim, fluopicolide, fluopyram, fluxapyroxad, fludioxonil, flucetosulfuron, flutianil, flutolanil, flufenoxuron, flubendiamide, flupoxam, flurprimidol, pretilachlor, prosulfocarb, flonicamid, propamocarb hydrochloride, prohydrojasmon, propyrisulfuron, bromobutide, penoxsulam, pencycuron, bensulfuron-methyl, benzobicyclon, benthiavalicarb-isopropyl, benthiocarb, penthiopyrad, pendimethalin, pentoxazone, penflufen, benfuresate, boscalid, mandipropamid, myclobutanil, milbemectin, mecoprop-P isopropylamine salt, metaldehyde, methoxyfenozide, metconazole, metominostrobin, metolachlor, S-metolachlor, mefenacet, mepronil, lufenuron, lepimectin, EPN, IBP, MPP (fenthion), PAP (phenthoate), 1-methylcyclopropene, and the like may be mentioned. Of these, imidacloprid, ethaboxam, kresoxim-methyl, clothianidin, cyflufenamid, spinetoram, spinosad, tebufenozide, bifenthrin, pyribencarb, fluacrypyrim, flutianil, flubendiamide, flupoxam, and the like are preferred.

In the aforementioned powdered agrochemical composition, a carrier which is insoluble in water such as clay may be used.

In the production method of the present invention, the amount of water to be added to the aforementioned powdered agrochemical composition can be adjusted appropriately by the component and the amount of the powdered agrochemical composition, although it is preferably from 5 to 25% by weight.

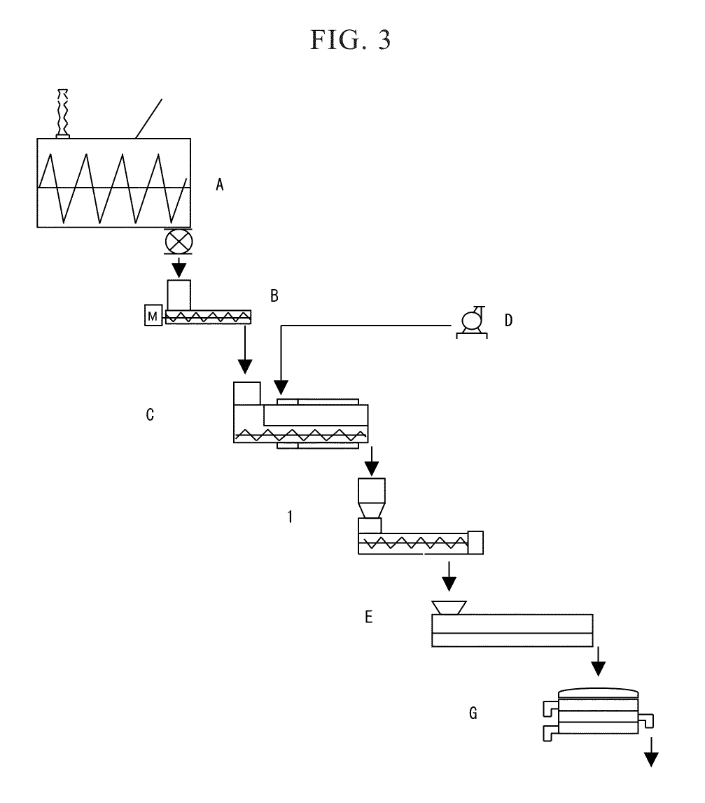

The aforementioned powdered agrochemical composition can be obtained by synthesizing the respective components, such as an agrochemical active ingredient, purifying and drying them by a known method, and then mixing and grinding the resultant, if necessary. For example, in the production facility shown in FIG. 3, an agrochemical active ingredient and an optional ingredient, such as a carrier, a surfactant, and a spreading agent are added to a mixing tank A, and are mixed in the mixing tank A. The resultant mixture is supplied to a continuous kneader C by adjusting the flow rate with a screw feeder B. In addition, water is supplied to the continuous kneader C at the same time by adjusting the flow rate with a metering pump D. The mixture and water are kneaded inside the continuous kneader C to yield a kneaded product 2 of the agrochemical composition and water.

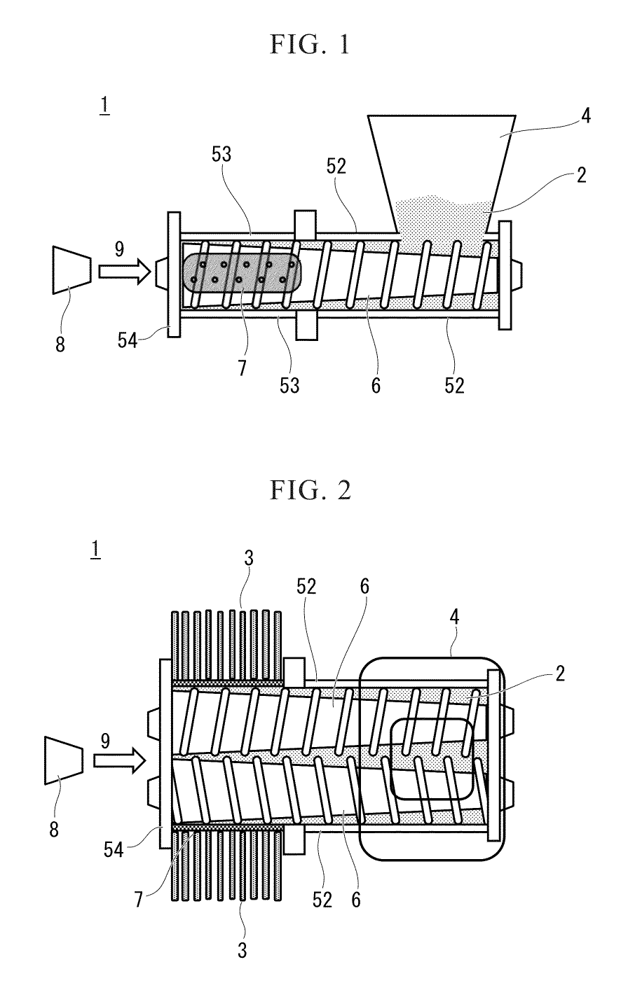

A lateral extrusion granulator 1 used in the present invention (FIGS. 1 and 2) includes: a hopper 4 for feeding the kneaded product 2 of the powdered agrochemical composition and water; a screw 6 for kneading and extruding the aforementioned kneaded product 2; a screw casing 5 for accommodating the aforementioned screw 6; a screen 7 for molding the kneaded product into strands which is provided on a screw casing wall 53 parallel to a screw shaft on a side away from the aforementioned hopper 4; and a cooling unit 8 for cooling a screw casing wall 54 on a bearing side of a screw on a side away from the hopper 4. The temperature of the screen 7 is preferably from 40 to 60° C.

In addition, the lateral extrusion granulator 1 used in the present invention may be configured in such a manner that the temperature of the screw 6 and the screw casing 5 can be controlled by allowing a refrigerant to flow into the inner cavity of the screw shaft or into the inner cavity of a screw casing wall 52 parallel to the screw shaft on the hopper side. Water is usually used as the refrigerant. The temperature of the cooling water to be flown into the screw shaft is preferably from 5 to 25° C. The temperature of the cooling water to be flown into the inner cavity of the screw casing wall 52 parallel to the screw shaft on the hopper side is preferably from 5 to 25° C. The measurement of the temperature can be conducted with an infrared sensor or the like.

In an embodiment of the present invention shown in FIG. 1 and FIG. 2, a cooling unit 8 is an air blower which blows a cooling air 9 to the screw casing wall 54 of the bearing side of the screw on the side away from the hopper 4. The temperature of the air to be blown is preferably from 0 to 25° C.

The temperature of the strand-like molded product immediately after being extruded from the screen 7 is preferably from 35 to 60° C. As shown in FIG. 3, the strand-like molded product is dried in a fluidized bed dryer E. The strand-like molded product is torn into short pieces during the fluidized drying to become granules. The resulting granules are classified with a circular vibration sieve G and adjusted into granules having a predetermined size.

### EXAMPLES

The present invention will be described below in more detail by showing an example and a comparative example.

### Comparative Example

A predetermined amount of water was added to a powdered agrochemical composition containing 20% by weight of acetamiprid serving as an agrochemical active ingredient and 45% by weight of lactose and the resultant was kneaded, and continuous production of a strand-like wet granulated product having a granule diameter of 0.7 mmcp was started at a rate of about 155 kg-wet/hr with a lateral extrusion granulator. The lateral extrusion granulator is configured so that two screws can carry out the kneading process by rotating inside the screw casing, and is equipped with a water-cooling function (water temperature: 20° C., pH: 3 to 9) for adjusting the temperature of the screw shaft and the screw casing parallel to the screw shaft on the hopper side and an air blower for cooling the wet granulated product extruded from the screen.

The obtained wet granulated product was dried continuously in an air dryer (not shown) in which the temperature was set to 65° C., thereby producing a granule having an apparent specific gravity of 0.544 to 0.593 and a granule diameter of 0.7 mmφ. The temperature of the wet granulated product immediately after the start of the production was 40° C.

When 24 hours had passed from the start of the continuous production, the screen on the side close to the hopper was blocked, and the strands extruded from the screen on the side away from the hopper were hardened into the shape of a yarn ball. The temperature of the wet granulated product at this time was more than 64° C.

Example

A predetermined amount of water was added to a powdered agrochemical composition containing 20% by weight of acetamiprid serving as an agrochemical active ingredient and 45% by weight of lactose and the resultant was kneaded, and continuous production of a strand-like wet granulated product 3 having a granule diameter of 0.7 mmφ was started at a rate of about 155 kg-wet/hr with a lateral extrusion granulator 1.

The lateral extrusion granulator 1 (FIGS. 1 and 2) is configured so that two screws 6 can carry out the kneading process by rotating inside the screw casing, and is equipped with a water-cooling function (water temperature: 20° C., pH: 3 to 9) for adjusting the temperature of the shafts of the screws 6 and the screw casing 52 parallel to the screw shaft on the hopper 4 side and an air blower (not shown) for cooling the wet granulated product 3 extruded from the screen 7. Furthermore, the lateral extrusion granulator 1 used in the example includes a cooling unit 8 (spot cooler), and is configured so that the cooling unit 8 sends a cooling air 9 of about 15° C. to a screw casing wall 54 of the screw shaft bearing side on the side away from the hopper 4.

The obtained wet granulated product 3 was dried continuously in an air dryer (not shown) in which the temperature was set to 65° C., thereby producing a granule having an apparent specific gravity of 0.544 to 0.593 and a granule diameter of 0.7 mmφ.

The temperature of the wet granulated product 3 immediately after the start of the production was 40° C.

Even after 48 hours had passed from the start of the continuous production, the screen was not blocked, and it was possible to stably produce the strand-like wet granulated product 3. The temperature of the wet granulated product 3 at this time was 45° C., and the temperature of the screen 7 was about 50° C.

### REFERENCE SIGNS LIST

1: Lateral extrusion granulator

2: Kneaded product

3: Wet granulated product

4: Hopper

5: Screw casing

52: Screw casing wall parallel to the screw shaft on the hopper side

53: Screw casing wall parallel to the screw shaft on the side away from the hopper

54: Screw casing wall on the bearing side of the screw on the side away from the hopper

6: Screw

7: Screen

8: Cooling unit (spot cooler)

9: Cooling air

1. A method for producing an agricultural and horticultural granule, the method comprising molding a powdered agrochemical composition into granules using a lateral extrusion granulator,
wherein said lateral extrusion granulator comprises:
a hopper for feeding a kneaded product of said powdered agrochemical composition and water;
a screw for kneading and extruding said kneaded product;
a screw casing for accommodating said screw;
a screen for molding said kneaded product into strands which is provided on a screw casing wall parallel to a screw shaft on a side away from said hopper; and
a cooling unit for cooling a screw casing wall on a bearing side of a screw on a side away from said hopper, and
wherein said powdered agrochemical composition comprises 20 to 80% by weight in total of a component having a water solubility of 4,000 to 500,000 ppm at a water temperature of 20° C. and a pH of 3 to 9.

2. The method for producing an agricultural and horticultural granule according to claim 1, wherein said cooling unit is a spot cooler.

3. The method for producing an agricultural and horticultural granule according to claim 2, wherein a temperature of an air blown by said spot cooler is from 0 to 25° C.

4. The method for producing an agricultural and horticultural granule according to claim 1,
wherein said powdered agrochemical composition comprises an agrochemical active ingredient having a water solubility of 4,000 to 500,000 ppm at a water temperature of 20° C. and a pH of 3 to 9.

5. The method for producing an agricultural and horticultural granule according to claim 4,
wherein said agrochemical active ingredient is a neonicotinoid-based insecticidal component.

6. The method for producing an agricultural and horticultural granule according to claim 5,
wherein said neonicotinoid-based insecticidal component is acetamiprid, dinotefuran, or thiamethoxam.

7. The method for producing an agricultural and horticultural granule according to claim 1,
wherein said powdered agrochemical composition comprises a carrier having a water solubility of 4,000 to 500,000 ppm at a water temperature of 20° C. and a pH of 3 to 9.

8. The method for producing an agricultural and horticultural granule according to claim 6,
wherein said carrier is a metal halide salt, a metal carbonate salt, a metal sulfate salt, an ammonium salt, urea, a monosaccharide, a disaccharide, or a polysaccharide.
